(19) United States
(12) Patent Application Publication
(10) Pub. No.: US 2025/0364182 A1
(43) Pub. Date: Nov. 27, 2025

(54) MULTILAYER CERAMIC CAPACITOR

(71) Applicant: Murata Manufacturing Co., Ltd., Nagaokakyo-shi (JP)

(72) Inventors: Kenji UENO, Nagaokakyo-shi (JP); Kosuke URATANI, Nagaokakyo-shi (JP); Shinya ISOTA, Nagaokakyo-shi (JP); Hiroyuki WADA, Nagaokakyo-shi (JP); Hiroshi ASANO, Nagaokakyo-shi (JP)

(21) Appl. No.: 19/295,829

(22) Filed: Aug. 11, 2025

Related U.S. Application Data
(63) Continuation of application No. PCT/JP2024/030407, filed on Aug. 27, 2024.

(30) Foreign Application Priority Data
Aug. 28, 2023 (JP) 2023-137936

(51) Int. Cl. H01G 4/12; H01G 4/248; H01G 4/30

(52) U.S. Cl. CPC H01G 4/1218; H01G 4/248; H01G 4/30

(57) ABSTRACT

A multilayer ceramic capacitor includes an inner-layer portion including first and second inner electrode layers alternately stacked with dielectric layers, a first primary surface, a second primary surface opposite the first primary surface, a first side surface, a second side surface opposite the first side surface, a first end surface, and a second end surface opposite the first end surface, a first outer-layer portion covering the first primary surface in the stacking direction, a second outer-layer portion covering the second primary surface in the stacking direction, and a pair of outer end surface electrodes on the first and second end surfaces. Each of the ceramic dielectrics of the inner-layer portion, the first outer-layer portion, and the second outer-layer portion includes dielectric particles with a void therein. Intragranular void densities in the ceramic dielectric in the inner-layer portion (Nᵢₙₙₑᵣ), and in the first and second portions (Nₒᵤₜₑᵣ) satisfy Nₒᵤₜₑᵣ<Nᵢₙₙₑᵣ.

### CROSS REFERENCE TO RELATED APPLICATIONS

This application claims the benefit of priority to Japanese Patent Application No. 2023-137936 filed on Aug. 28, 2023 and is a Continuation Application of PCT Application No. PCT/JP2024/030407 filed on Aug. 27, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

As electronic devices, typically mobile phones, become smaller and CPUs become faster, the need for multilayer ceramic capacitors (MLCCs) has been increasingly growing. A multilayer ceramic capacitor includes dielectric layers with a high dielectric constant formed as thin layers. A multilayer ceramic capacitor, therefore, has a large electrostatic capacitance despite being compact. Multilayer ceramic capacitors made with various materials are known, but ones made using ceramic dielectrics, such as barium titanate (BaTiO₃), in the dielectric layers and non-precious metals, such as nickel (Ni), in inner electrode layers are commonly used because they are inexpensive and exhibit high characteristics.

A multilayer ceramic capacitor includes an inner-layer portion, in which dielectric layers including a ceramic dielectric and inner electrode layers are alternately stacked, and outer-layer portions, which cover the top and bottom of the inner-layer portion. The inner-layer portion is a region that serves as a capacitive element, and the outer-layer portions are regions including no inner electrode layer that are provided above and below the inner-layer portion. The outer portions can be regarded as acting to protect the inner-layer portion, which serves as a capacitive element, from the external environment.

Incidentally, ceramic dielectrics used in multilayer ceramic capacitors are produced by sintering dielectric powders, such as BaTiO₃ powders. The dielectric powders are synthesized using methods such as the solid-phase method, the hydrothermal method, the sol-gel method, the alkoxide hydrolysis method, the solvothermal method, and the oxalate method. Of these, the hydrothermal method (hydrothermal synthesis) is a method in which a high-temperature and high-pressure aqueous solution is used to synthesize an inorganic powder and offers the advantage that fine powders with uniform particle size can be manufactured at a relatively low cost. Manufacturing a multilayer ceramic capacitor using dielectric powders synthesized by the hydrothermal method (hydrothermally synthesized dielectric powders), therefore, allows for reducing the thickness of the dielectric layers and increasing their capacitance. Variations in the diameter of dielectric particles, furthermore, are reduced, which allows for seeking improvements in the dielectric constant and reliability.

In the hydrothermal method, hydroxides are used as raw materials. For example, a Ba source, such as barium hydroxide (Ba(OH)₂), and a Ti source, such as a metatitanate (TiO(OH)₂) or titanium oxide (TiO₂), are allowed to react in high-temperature and high-pressure water, and the resulting reaction product is subjected to heat treatment to give a BaTiO₃ powder. The OH groups included in the hydroxides leave the raw materials during the heat treatment, but as a result of this, voids are created inside the particles of the dielectric powder (intragranular voids). Manufacturing a multilayer ceramic capacitor using dielectric powders having intragranular voids, furthermore, results in the intragranular voids remaining in the finished capacitor. When dielectric powders synthesized by methods other than the hydrothermal method are used, by contrast, no intragranular voids are created.

In Japanese Unexamined Patent Application Publication No. 2019-102655, the use of a hydrothermally synthesized dielectric powder in the dielectric layers of a multilayer ceramic capacitor is disclosed. Specifically, a method for manufacturing a ceramic capacitor is disclosed that includes a production step in which green sheets are produced using a ceramic slurry including a first ceramic powder synthesized by the hydrothermal method and a second ceramic powder synthesized by a method other than the hydrothermal method and a step of firing the resulting green sheets (See, for example, claim 5 of Japanese Unexamined Patent Application Publication No. 2019-102655). In Japanese Unexamined Patent Application Publication No. 2019-102655, furthermore, it is also stated that pores (voids) present within the ceramic particles alleviate piezoelectric strain, which leads to the reduction of cracks (See, for example, [0031] of Japanese Unexamined Patent Application Publication No. 2019-102655).

### SUMMARY OF THE INVENTION

As described above, the manufacture of a multilayer ceramic capacitor using a hydrothermally synthesized dielectric powder has hitherto been proposed. As a result of studies by the inventors, however, it was discovered that such a multilayer ceramic capacitor has a problem with moisture resistance. As a possible cause of this, furthermore, the presence of intragranular voids was suspected. More specifically, as stated above, multilayer ceramic capacitors made using a hydrothermally synthesized dielectric powder may have intragranular voids remaining in ceramic dielectrics. In addition, the inventors considered that when intragranular voids remain in the ceramic dielectrics of the outer-layer portions, they bring about reduced moisture resistance. The inventors also speculated that when numerous intragranular voids remain simultaneously, denseness also decreases.

As a result of further investigation by the inventors, it was discovered that a multilayer ceramic capacitor particularly superior in moisture resistance can be obtained by controlling the densities of intragranular voids in the inner-layer portion and outer-layer portions of the multilayer ceramic capacitor such that they satisfy a predetermined relationship.

Example embodiments of the present invention provide multilayer ceramic capacitors that are particularly superior in moisture resistance.

In the description of example embodiments of the present invention, it should be noted that a range expressed using (“from” and) “to” herein includes the values at both ends. That is, “(from) X to Y” is synonymous with “X or more and Y or less.”

According to an example embodiment of the present invention, a multilayer ceramic capacitor that includes an inner-layer portion, in which at least one first inner electrode layer and at least one second inner electrode layer are alternately stacked with at least one dielectric layer including a ceramic dielectric interposed therebetween, the inner-layer portion including a first primary surface facing a stacking direction, a second primary surface opposite the first primary surface, a first side surface facing a width direction orthogonal to the first primary surface and the second primary surface, a second side surface opposite the first side surface, a first end surface facing a length direction, orthogonal to the first primary surface, the second primary surface, the first side surface, and the second side surface, and to which the first inner electrode layer is extended, and a second end surface opposite the first end surface and to which the second inner electrode layer is extended, a first outer-layer portion including a ceramic dielectric and covering the first primary surface in the stacking direction, a second outer-layer portion including a ceramic dielectric and covering the second primary surface in the stacking direction, and a pair of outer end surface electrodes on the first end surface and the second end surface and coupled to each of the first inner electrode layer and the second inner electrode layer, wherein each of the ceramic dielectrics of the inner-layer portion, the first outer-layer portion, and the second outer-layer portion includes a plurality of dielectric particles including a void therein, and an intragranular void density in the ceramic dielectric in the inner-layer portion (Nᵢₙₙₑᵣ) and intragranular void densities in the ceramic dielectrics in the first outer-layer portion and the second outer-layer portion (Nₒᵤₜₑᵣ) satisfy formula (1): Nₒᵤₜₑᵣ<Nᵢₙₙₑᵣ.

According to another example embodiment of the present invention, a multilayer ceramic capacitor includes an inner-layer portion including at least one first inner electrode layer and at least one second inner electrode layer alternately stacked with at least one dielectric layer including a ceramic dielectric interposed therebetween, the inner-layer portion including a first primary surface facing a stacking direction, a second primary surface opposite the first primary surface, a first side surface facing a width direction orthogonal to the first primary surface and the second primary surface and to which the second inner electrode layer is extended, a second side surface opposite the first side surface and to which the second inner electrode layer is extended, a first end surface facing a length direction, orthogonal to the first primary surface, the second primary surface, the first side surface, and the second side surface, and to which the first inner electrode layer is extended, and a second end surface opposite the first end surface and to which the first inner electrode layer is extended, a first outer-layer portion including a ceramic dielectric and covering the first primary surface in the stacking direction, a second outer-layer portion including a ceramic dielectric and covering the second primary surface in the stacking direction, a pair of outer end surface electrodes on the first end surface and the second end surface and coupled to the first inner electrode layer, and a pair of outer side surface electrodes on the first side surface and the second side surface and coupled to the second inner electrode layer, wherein each of the ceramic dielectrics of the inner-layer portion, the first outer-layer portion, and the second outer-layer portion includes a plurality of dielectric particles including a void therein, and an intragranular void density in the ceramic dielectric in the inner-layer portion (Nᵢₙₙₑᵣ) and intragranular void densities in the ceramic dielectrics in the first outer-layer portion and the second outer-layer portion (Nₒᵤₜₑᵣ) satisfy formula (1): Nₒᵤₜₑᵣ<Nᵢₙₙₑᵣ.

According to example embodiments of the present invention, multilayer ceramic capacitors that are particularly superior in moisture resistance are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an example of a perspective view illustrating the external shape of a multilayer ceramic capacitor according to an example embodiment of the present invention.

FIG. 2 is a cross-sectional view schematically illustrating an internal structure of a multilayer ceramic capacitor according to an example embodiment of the present invention.

FIG. 3 is a cross-sectional view schematically illustrating an internal structure of a multilayer ceramic capacitor according to an example embodiment of the present invention.

FIG. 4 is another example of a perspective view illustrating an external shape of a multilayer ceramic capacitor according to an example embodiment of the present invention.

### DETAILED DESCRIPTION OF THE EXAMPLE EMBODIMENTS

Specific example embodiments of the present invention (hereinafter referred to as “this example embodiment”) will be described. It should be noted that the present invention is not limited to the following example embodiments, and various modifications are possible within the gist of the present invention.

### 1. Multilayer Ceramic Capacitor

A multilayer ceramic capacitor according to an example embodiment includes an inner-layer portion, a first outer-layer portion, a second outer-layer portion, and a pair of outer end surface electrodes. The inner-layer portion is a region in which first inner electrode layers and second inner electrode layers are alternately stacked with dielectric layers including a ceramic dielectric interposed therebetween. The inner-layer portion includes a first primary surface and a second primary surface, a first side surface and a second side surface, and a first end surface and a second end surface. The first primary surface is a surface facing the direction in which the dielectric layers, the first inner electrode layers, and the second electrode layers are stacked. The second primary surface is the surface opposite the first primary surface. The first side surface is a surface facing the width direction, orthogonal to the first primary surface and the second primary surface. The second side surface is the surface opposite the first side surface. The first end surface is a surface facing the length direction, orthogonal to the first primary surface, the second primary surface, the first side surface, and the second side surface. The second end surface is the surface opposite the first end surface. The first inner electrode layers are extended to the first end surface. The second inner electrode layers are extended to the second end surface. The first outer-layer portion includes a ceramic dielectric and covers the first primary surface in the stacking direction. The second outer-layer portion includes a ceramic dielectric and covers the second primary surface in the stacking direction. The pair of outer end surface electrodes are provided on the first end surface and the second end surface and coupled to each of the first inner electrode layers and the second inner electrode layers. Each of the ceramic dielectrics of the inner-layer portion, the first outer-layer portion, and the second outer-layer portion includes multiple dielectric particles including a void therein. The intragranular void density in the ceramic dielectric in the inner-layer portion (Nᵢₙₙₑᵣ) and the intragranular void densities in the ceramic dielectrics in the first outer-layer portion and the second outer-layer portion (Nₒᵤₜₑᵣ) satisfy formula (1): Nₒᵤₜₑᵣ<Nᵢₙₙₑᵣ.

A multilayer ceramic capacitor according to another example embodiment includes an inner-layer portion, a first outer-layer portion, a second outer-layer portion, a pair of outer end surface electrodes, and a pair of outer side surface electrodes. The inner-layer portion is a region in which first inner electrode layers and second inner electrode layers are alternately stacked with dielectric layers including a ceramic dielectric interposed therebetween. The inner-layer portion includes a first primary surface and a second primary surface, a first side surface and a second side surface, and a first end surface and a second end surface. The first primary surface is a surface facing the direction in which the dielectric layers, the first inner electrode layers, and the second electrode layers are stacked. The second primary surface is the surface opposite the first primary surface. The first side surface is a surface facing the width direction, orthogonal to the first primary surface and the second primary surface. The second side surface is the surface opposite the first side surface. The second inner electrode layers are extended to the first side surface and the second side surface. The first end surface is a surface facing the length direction, orthogonal to the first primary surface, the second primary surface, the first side surface, and the second side surface. The second end surface is the surface opposite the first end surface. The first inner electrode layers are extended to the first end surface and the second end surface. The first outer-layer portion includes a ceramic dielectric and covers the first primary surface in the stacking direction. The second outer-layer portion includes a ceramic dielectric and covers the second primary surface in the stacking direction. The pair of outer end surface electrodes are provided on the first end surface and the second end surface and coupled to the first inner electrode layers. The pair of outer side surface electrodes are provided on the first side surface and the second side surface and coupled to the second inner electrode layers. Each of the ceramic dielectrics of the inner-layer portion, the first outer-layer portion, and the second outer-layer portion includes multiple dielectric particles including a void therein. The intragranular void density in the ceramic dielectric in the inner-layer portion (Nᵢₙₙₑᵣ) and the intragranular void densities in the ceramic dielectrics in the first outer-layer portion and the second outer-layer portion (Nₒᵤₜₑᵣ) satisfy formula (1): Nₒᵤₜₑᵣ<Nᵢₙₙₑᵣ.

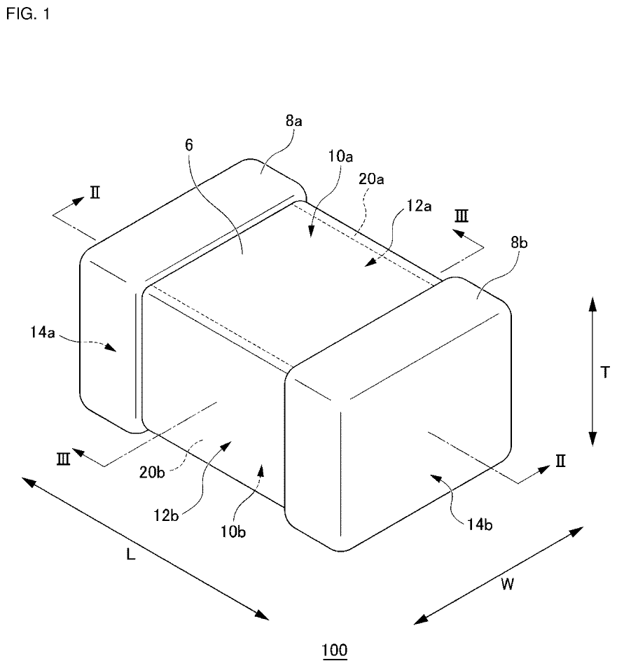

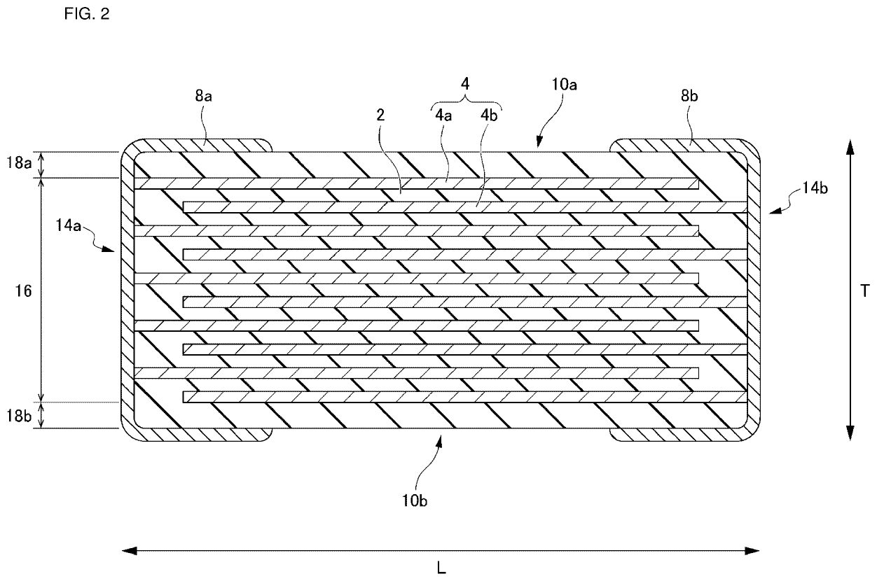

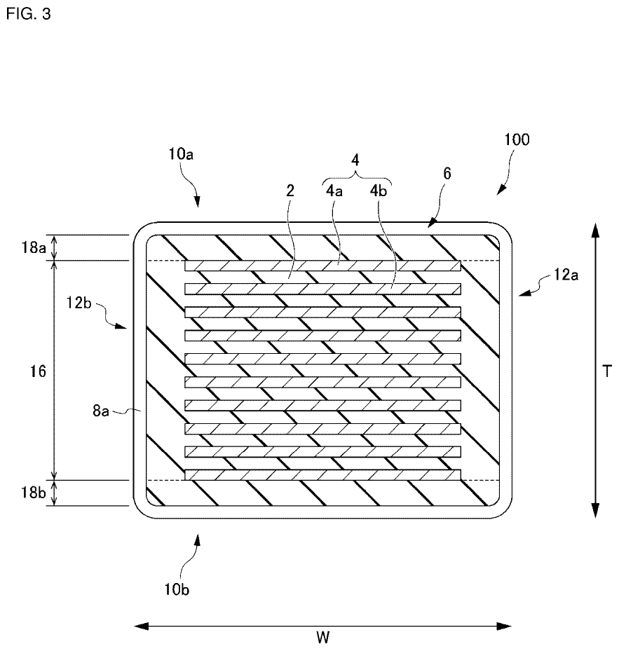

A multilayer ceramic capacitor according to an example embodiment of the present invention will be described using FIG. 1 to FIG. 3. FIG. 1 is a perspective view illustrating the external shape of the multilayer ceramic capacitor. FIG. 2 is a cross-section of the multilayer ceramic capacitor illustrated in FIG. 1 taken along line II-II, and FIG. 3 is a cross-sectional view taken along line III-III.

The multilayer ceramic capacitor (100) includes a body portion (6) and a pair of outer end surface electrodes (8a, 8b), which are provided on both end surfaces (14a, 14b) of this body portion (6). The multilayer ceramic capacitor (100) and the body portion (6) have a substantially rectangular parallelepiped shape. A substantially rectangular parallelepiped encompasses not only a rectangular parallelepiped but also a rectangular parallelepiped whose corner portions and/or edge portions are rounded.

The multilayer ceramic capacitor (100) and the body portion (6) include a first outer primary surface (10a) and a second outer primary surface (10b) facing each other in the thickness direction T, a first outer side surface (12a) and a second outer side surface (12b) facing each other in the width direction W, and a first outer end surface (14a) and a second outer end surface (14b) facing each other in the length direction L. In this context, the thickness direction T is the direction in which dielectric layers (2) and inner electrode layers (4), included in the body portion (6), are stacked. The length direction L is the direction that is orthogonal to the thickness direction T and in which the outer end surfaces (14a, 14b) are opposite each other. The width direction W is the direction orthogonal to the thickness direction T and the length direction L. A plane including the thickness direction T and the width direction W is defined as a WT plane, a plane including the width direction W and the length direction L is defined as an LW plane, and a plane including the length direction L and the thickness direction T is defined as an LT plane.

The body portion (6) includes an inner-layer portion (16), a first outer-layer portion (18a), and a second outer-layer portion (18b).

The inner-layer portion (16) is a region in which inner electrode layers (4) are alternately stacked with dielectric layers (2) interposed therebetween. The dielectric layers (2) include a ceramic dielectric. The inner electrode layers (4) include multiple first inner electrode layers (4a) and multiple second inner electrode layers (4b).

The inner-layer portion (16) includes a first primary surface, a second primary surface, a first side surface, a second side surface, a first end surface, and a second end surface. The first primary surface is a surface perpendicular to the direction in which the dielectric layers (2) and the inner electrode layers (4a, 4b) are stacked. The second primary surface is the surface opposite (the surface facing) the first primary surface. The first side surface is a surface orthogonal to the first primary surface and the second primary surface, i.e., a surface perpendicular to the width direction W. The second side surface is the surface opposite (the surface facing) the first side surface. The first end surface is a surface orthogonal to the first primary surface, the second primary surface, the first side surface, and the second side surface, i.e., a surface perpendicular to the length direction L. The second end surface is the surface opposite (the surface facing) the first end surface. The inner electrode layers (4a, 4b) are not extended to the first side surface and the second side surface. The first inner electrode layers (4a) are extended to the first end surface, but the second inner electrode layers (4b) are not extended to the first end surface. The second inner electrode layers (4b) are extended to the second end surface, but the first inner electrode layers (4a) are not extended to the second end surface.

The first outer-layer portion (18a) is a region that covers the first primary surface of the inner-layer portion (16) in the stacking direction (thickness direction T). The second outer-layer portion (18b) is a region that covers the second primary surface of the inner-layer portion (16) in the stacking direction. The first outer-layer portion (18a) and the second outer-layer portion (18b) include ceramic dielectrics.

The outer end surface electrodes (8a, 8b) include a first outer end surface electrode (8a), which is provided on the first outer end surface (14a) of the body portion (6), and a second outer end surface electrode (8b), which is provided on the second outer end surface (14b). The first outer end surface electrode (8a) is electrically coupled to the first inner electrode layers (4a). The second outer end surface electrode (8b) is electrically coupled to the second inner electrode layers (4b). In the multilayer ceramic capacitor (100). However, the first outer end surface electrode (8a) and the second outer end surface electrode (8b) are not coupled together, and instead they are electrically separated.

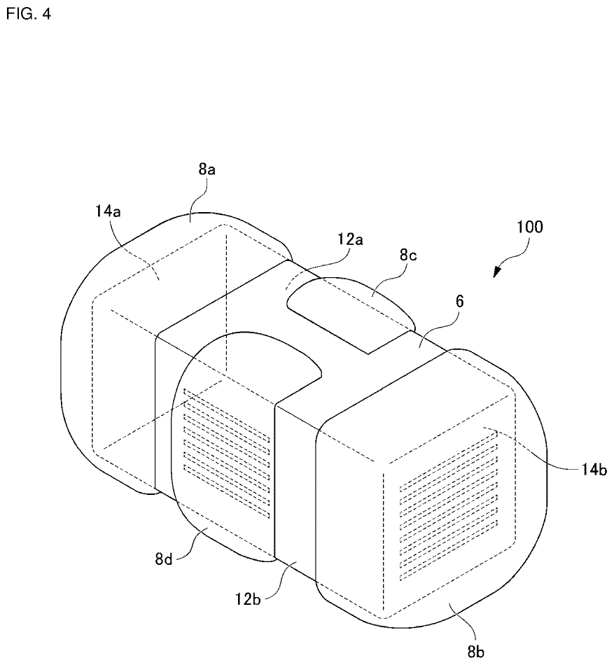

An external perspective view of a multilayer ceramic capacitor according to another example embodiment of the present invention is presented in FIG. 4. The multilayer ceramic capacitor according to this example embodiment of the present invention is a so-called three-terminal capacitor, which includes outer electrodes on the end surfaces and the side surfaces (outer end surface electrodes and outer side surface electrodes). In this example embodiment, the structure excluding the inner electrode layers and the outer electrodes is the same as in the above-described example embodiment.

In the present example embodiment, the first inner electrode layers (4a) are extended to the end surfaces (the first end surface and the second end surface) of the inner-layer portion, but are not extended to the side surfaces (the first side surface and the second side surface). The second inner electrode layers (4b) are extended to the side surfaces (the first side surface and the second side surface) of the inner-layer portion, but are not extended to the end surfaces (the first end surface and the second end surface).

A first outer end surface electrode (8a) and a second outer end surface electrode (8b) are provided on the first outer end surface (14a) and second outer end surface (14b), respectively, of the body portion (6), and a first outer side surface electrode (8c) and a second outer side surface electrode (8d) are provided on the first outer side surface (12a) and the second outer side surface (12b), respectively. Both the outer end surface electrodes (8a, 8b) are electrically coupled to the first inner electrode layers (4a). Both the outer side surface electrodes (8c, 8d) are electrically coupled to the second inner electrode layers (4b). The outer end surface electrodes (8a, 8b) and the outer side surface electrodes (8c, 8d) are not coupled together, and instead they are electrically separated.

In both of the example embodiments of the present invention described above, the sizes of the multilayer ceramic capacitor (100) and the body portion (6) are not particularly limited. For example, the dimension in the length direction L is about 0.2 mm or more and about 3.2 mm or less, the dimension in the width direction W is about 0.1 mm or more and about 2.5 mm or less, and the dimension in the stacking direction T is about 0.1 mm or more and about 2.5 mm or less, for example. It should be noted that although in FIGS. 1 to 3 the multilayer ceramic capacitor is illustrated such that the dimension in the length direction L is greater than the dimension in the width direction W, multilayer ceramic capacitors according to example embodiments of the present invention are not limited to ones having such dimensions. The dimension in the length direction L may be smaller than the dimension in the width direction W.

### Inner-Layer Portion-Dielectric Layers

The inner-layer portion is a region in which inner electrode layers (first inner electrode layers and second inner electrode layers) are alternately stacked with dielectric layers including a ceramic dielectric interposed therebetween. The dielectric layers include a ceramic dielectric produced by firing inner-layer green sheets, which include a dielectric raw material. The ceramic dielectric is based on a sintered polycrystal (ceramic) in which numerous dielectric particles are bound together with grain boundaries and triple points interposed therebetween. In other words, the ceramic dielectric includes dielectric particles (dielectric grains) as its primary element. It should be noted that the primary element is the element with the highest percentage, or the element present at about 50% by mass or more, in the ceramic dielectric.

A perovskite oxide has a composition represented by the general formula: ABO₃, and has a cubic-like crystal structure, such as cubic, tetragonal, orthorhombic, or rhombohedral, at room temperature. Each of the atoms of the A-site element (hereinafter “A-site atoms”) and the atoms of the B-site element (hereinafter

“B-site atoms”), furthermore, becomes ionized and occupies the A-site or B-site in the perovskite structure. Examples of A-site elements include elements with relatively large ionic sizes, such as barium (Ba), calcium (Ca), and strontium (Sr), and examples of B-site elements include elements with relatively small ionic sizes, such as titanium (Ti), zirconium (Zr), and hafnium (Hf). The combination of the A-site element and the B-site element is not particularly limited, as long as the perovskite structure is maintained. Each of the A-site element and the B-site element may include only one element or may alternatively include multiple elements in combination. Moreover, as long as the perovskite structure is maintained, the molar ratio between the A-site element and the B-site element may deviate from 1:1.

Specific examples of perovskite oxides include barium titanate (BaTiO₃) compounds, calcium titanate (CaTiO₃) compounds, or strontium titanate (SrTiO₃) compounds, or their mixed crystals and solid solutions. Preferably, the A-site element includes barium (Ba), with the B-site element including titanium (Ti). That is, the perovskite oxide is preferably a barium titanate (BaTiO₃) compound. It should be noted that BaTiO₃ compounds encompass not only BaTiO₃ but also compounds in which a portion of the Ba in BaTiO₃ has been replaced with other A-site elements, such as Sr and/or Ca, or compounds in which a portion of the Ti in BaTiO₃ has been replaced with other B-site elements, such as Zr and/or Hf.

The ceramic dielectric may include secondary elements. Examples of secondary elements include rare earth elements (REs), magnesium (Mg), manganese (Mn), iron (Fe), chromium (Cr), cobalt (Co), nickel (Ni), silicon (Si), aluminum (Al), or vanadium (V), or their compounds, although not limited. The ceramic dielectric may include one such element alone as a secondary element or may include multiple elements in combination. The form in which the secondary elements exist is not limited. The secondary elements only need to be included in any of the dielectric particles, grain boundaries, or triple points.

The dielectric particles may include core-shell particles. A core-shell particle refers to a particle having a structure in which at least a subset of secondary elements is dissolved at high concentrations in the surface layer (shell portion) of the particle, with the secondary elements being dissolved at low concentrations or the secondary elements not dissolved in the middle portion (core portion) of the particle (core-shell structure). Alternatively, the dielectric particles may include uniform solid-solution particles.

The thickness of the dielectric layers occupying the inner-layer portion is preferably about 0.3 um or more and about 0.5 μm or less, for example. Setting the thickness of the dielectric layers equal to or greater than a predetermined value allows for reducing the occurrence of dielectric breakdown during the use of the multilayer ceramic capacitor and service life degradation. Setting the thickness of the dielectric layers equal to or smaller than a predetermined value, furthermore, allows for further increasing the capacitance of the multilayer ceramic capacitor because the dielectric layers are formed as thin layers. The number of dielectric layers is not particularly limited. Preferably, the number of dielectric layers of the outer-layer portions and the inner-layer portion is 100 or more and 2000 or fewer, for example.

### Inner-Layer Portion-Inner Electrode Layers

The inner electrode layers (the first inner electrode layers and the second inner electrode layers) include a facing electrode portion and an extended electrode portion and provide the inner-layer portion together with the dielectric layers. The facing electrode portion acts to allow the dielectric layers to exhibit their function as capacitive elements by sandwiching them. The extended electrode portion extends to the end surfaces and/or side surfaces of the inner-layer portion and acts to electrically couple the facing electrode portion and the outer electrodes (the outer end surface electrodes and the outer side surface electrodes) there. The inner electrode layers include at least one conductive metal. The conductive metal can be any one or more known electrode materials, such as nickel (Ni), copper (Cu), silver (Ag), palladium (Pd), a silver (Ag)-palladium (Pd) alloy, and/or gold (Au). The inner electrode layers are produced by sintering conductive paste layers formed on the surface of inner-layer green sheets by printing.

The inner electrode layers may include additional elements, other than the conductive metal. An example of an additional element is a ceramic element that acts as a common material. The thickness of the inner electrode layers, furthermore, is preferably about 0.30 μm or more and about 0.40 μm or less, for example. By setting the thickness of the inner electrodes equal to or greater than a predetermined value, the occurrence of problems such as broken electrodes can be prevented. By setting the thickness equal to or smaller than a predetermined value, furthermore, a decrease in the percentage that the dielectric layers define in the capacitor can be prevented, contributing to increasing the capacitance. Moreover, the number of inner electrode layers is preferably 10 or more and 1000 or fewer, for example.

### Outer-Layer Portions

The outer-layer portions (the first outer-layer portion and the second outer-layer portion) are provided above and below the inner-layer portion, one on each side. The outer-layer portions are regions including ceramic dielectrics and including no inner electrode layer therein. The outer-layer portions are produced by firing outer-layer green sheets, which include a dielectric raw material.

### Outer Electrodes

The outer electrodes (the outer end surface electrodes and the outer side surface electrodes) act as input/output terminals of the multilayer ceramic capacitor. The capacitor according to an example embodiment of the present invention includes only outer end surface electrodes (a first outer end surface electrode and a second outer end surface electrode), which are provided on both end surfaces. The capacitor according to another example embodiment of the present invention includes outer end surface electrodes (a first outer end surface electrode and a second outer end surface electrode), which are provided on both end surfaces, and outer side surface electrodes (a first outer side surface electrode and a second outer side surface electrode), which are provided on both side surfaces. For the outer electrodes, known configurations can be used. For example, the outer electrodes may include a base electrode layer and a plating layer disposed on it. Alternatively, the outer electrodes may be formed solely using a plating layer, without providing a base electrode layer.

### Intragranular Void Densities

In a multilayer ceramic capacitor according to this example embodiment, each of the ceramic dielectrics of the inner-layer portion, the first outer-layer portion, and the second outer-layer portion includes multiple dielectric particles including a void therein. That is, these ceramic dielectrics are produced using hydrothermally synthesized dielectric powders.

In a multilayer ceramic capacitor according to this example embodiment, the intragranular void density in the ceramic dielectric in the inner-layer portion (hereinafter also collectively referred to as “the inner-layer ceramic”) (Nᵢₙₙₑᵣ) and the intragranular void densities in the ceramic dielectrics in the outer-layer portions (the first outer-layer portion and the second outer-layer portion) (hereinafter also collectively referred to as “the outer-layer ceramics”) (Nₒᵤₜₑᵣ) satisfy formula (1): Nₒᵤₜₑᵣ<Nᵢₙₙₑᵣ. In this context, an intragranular void density is the number of intragranular voids per unit area in a cross-section that passes through the middle portion in the length direction (WT plane) of the multilayer ceramic capacitor. An intragranular void, furthermore, is a void present inside a dielectric particle of a ceramic dielectric. In other words, an intragranular void is a region present inside a dielectric particle and including no solid element, such as the primary element of the dielectric particle or intentionally added secondary elements. An intragranular void, therefore, is distinguished from an extragranular void, which is present at a boundary or triple point between particles. A particle including a void therein is referred to as a voided particle.

Controlling the intragranular void density(ies) in each of the inner-layer ceramic and the outer-layer ceramics to satisfy the relationship specified above allows for achieving the advantage of improved moisture resistance while ensuring the advantage provided by intragranular voids in the inner-layer portion.

To describe this, the inner-layer ceramic is a region having the function as a capacitive element. Providing intragranular voids in the inner-layer ceramic allows for improving characteristics of the multilayer ceramic capacitor. As stated earlier, intragranular voids are created by using a hydrothermally synthesized dielectric powder as a raw material. Using a hydrothermally synthesized dielectric powder, on the other hand, allows for reducing the thickness of the multilayer ceramic capacitor and increasing its capacitance. Variations in the diameter of dielectric particles, furthermore, are reduced, which allows for seeking improvements in the dielectric constant and reliability. In addition to these, particles having an intragranular void (voided particles) exhibit high crystallinity in the periphery of the void, helping reduce the occurrence of problems caused by the diffusion of secondary element elements. As a result, improvements in characteristics can be sought. For example, when the dielectric particles are core-shell particles, the diffusion and dissolution of secondary elements do not proceed more than necessary, even if grain growth is induced in the firing step. Because grain growth can occur without destructing the core-shell structure, a high dielectric constant combined with flat temperature profiles and excellent reliability can be sought.

When the thickness of the dielectric layers is about 0.5 μm or less, it is preferred that the intragranular void density in the inner-layer ceramic be somewhat high to obtain conforming products and to ensure reliability. The intragranular void density is preferably about 8 voids/μm² or more and about 18 voids/μm² or less, more preferably about 11 voids/μm⁻or more and about 18 voids/μm² or less, for example. It should be noted that an intragranular void density can be determined by observing a cross-section that passes through the middle portion in the length direction (WT plane) of the multilayer ceramic capacitor using a transmission electron microscope (TEM). Specifically, an 80-nm thick TEM observation sample including a WT plane is prepared. The resulting sample is observed using a TEM in a 2-μm square field of view, and the number of intragranular voids is counted. Then the number of voids per unit area (1 μm²) is calculated by dividing the obtained number by the area of the ceramic portion (dielectric layer), the same operation is performed at three points (n=3), and the average number of intragranular voids per unit area is determined as the intragranular void density. In addition, the average diameter of the voids is preferably about 10 nm or more and about 50 nm or less, particularly preferably about 10 nm or more and about 30 nm or less, for example.

By contrast, the outer-layer ceramics, which sandwich the inner-layer ceramic vertically, do not act as capacitive elements. When the outer-layer ceramics have an excessively large number of intragranular voids, furthermore, moisture resistance may decrease. More specifically, the outer-layer ceramics include no inner electrode layer. They are not affected by the stress from the inner electrode layers in the firing step during the manufacture of the multilayer ceramic capacitor and thus tend to exhibit low sinterability compared to the inner-layer ceramic. When the outer-layer ceramics, which are of low sinterability, have intragranular voids, it becomes easier for water in the external environment to penetrate through these voids. The water that penetrates can reach the inner-layer ceramic, which acts as a capacitive element, potentially causing problems such as reduced insulation resistance.

Limiting the intragranular void densities in the outer-layer ceramics to be smaller than the intragranular void density in the inner-layer ceramic, therefore, allows for achieving the advantage of improved moisture resistance while ensuring the advantage provided by the intragranular voids in the inner-layer ceramic. For this reason, in this example embodiment, formula (1): Nₒᵤₜₑᵣ<Nᵢₙₙₑᵣ is preferably satisfied.

It is, however, effective to provide certain quantities of intragranular voids in the outer-layer ceramics, provided that formula (1) above is satisfied. More specifically, to reduce the thickness of the dielectric layers in the inner-layer portion and thereby improve reliability, it is necessary to limit variations in the diameter of dielectric particles across the entire electrically effective inner-layer ceramic. In limiting variations in particle diameter in the effective portions of the inner-layer ceramic that are in contact with the outer-layer ceramics, the presence of intragranular voids in the outer-layer ceramics is advantageous, regardless of the quantity.

From the viewpoint of seeking a reduction in the thickness of the dielectric layers and an improvement in reliability while maintaining excellent moisture resistance, it is preferred that the intragranular void densities in the outer-layer ceramics (Nₒᵤₜₑᵣ) be, for example, about 3 voids/μm² or more and about 13 voids/μm² or less, more preferably about 3 voids/μm² or more and about 11 voids/μm² or less, provided that formula (1) above is satisfied.

It should be noted that the outer-layer ceramics include a section corresponding to the first outer-layer portion and a section corresponding to the second outer-layer portion. The intragranular void density in the section corresponding to the first outer-layer portion and the intragranular void density in the section corresponding to the second outer-layer portion may be the same or may alternatively be different. As long as both are smaller than the intragranular void density in the inner-layer ceramic, their numerical relationship is not limited.

According to a preferred configuration, the zirconium (Zr) concentration in the inner-layer ceramic (Zrᵢₙₙₑᵣ) and the zirconium (Zr) concentrations in the outer-layer ceramics (Zrₒᵤₜₑᵣ) satisfy formula (2): Zrᵢₙₙₑᵣ<Zrₒᵤₜₑᵣ. As will be described later, adding grain growth accelerator materials, such as Zr, to the outer-layer green sheets and setting their amounts higher than those in the inner-layer green sheets during the manufacture of the multilayer ceramic capacitor help would limit the intragranular void densities in the outer-layer ceramics. In that case, furthermore, the concentrations of the grain growth accelerator materials (such as Zr) in the outer-layer ceramics would be higher than those in the inner-layer ceramic in the finally obtained multilayer ceramic capacitor. It should be noted that the Zr concentration in the section corresponding to the first outer-layer portion and the Zr concentration in the section corresponding to the second outer-layer portion may be the same or may alternatively be different, as long as both are higher than the Zr concentration in the inner-layer ceramic.

According to another preferred configuration, the average diameter of dielectric particles in the inner-layer ceramic (D50ᵢₙₙₑᵣ) and the average diameters of dielectric particles in the outer-layer ceramics (D50ₒᵤₜₑᵣ) satisfy formula (3): D50ᵢₙₙₑᵣ<D50ₒᵤₜₑᵣ. By accelerating grain growth in the outer-layer ceramics during the manufacture of the multilayer ceramic capacitor, the intragranular void densities there can be limited. It should be noted that the average particle diameter in the section corresponding to the first outer-layer portion and the average particle diameter in the section corresponding to the second outer-layer portion may be the same or may alternatively be different, as long as both are larger than the average particle diameter in the inner-layer ceramic.

Preferably, the average diameter of dielectric particles in the inner-layer ceramic (D50ᵢₙₙₑᵣ) is about 130 nm or more and about 210 nm or less, for example. By setting the average particle diameter equal to or greater than a predetermined value, it can be ensured that the particles exhibit crystallinity, and that the advantages of improved characteristics associated with it are produced. By setting the average particle diameter equal to or smaller than a predetermined value, furthermore, an increase in the capacitance of the multilayer ceramic capacitor can be sought by reducing the thickness of the dielectric layers. In addition, the advantage of improved reliability is also delivered. It should be noted that these average particle diameters are the average diameters of the entire populations of dielectric particles, including not only voided particles but also particles including no void.

### 2. Method for Manufacturing the Multilayer Ceramic Capacitor

For a multilayer ceramic capacitor according to this example embodiment, the method for manufacturing it is not limited as long as it satisfies the preferences described above. A preferred manufacturing method, however, includes the following steps: a step of synthesizing primary element powders for ceramic dielectrics (synthesis step), a step of mixing secondary element raw materials into the primary element powders to obtain dielectric raw materials (mixing step), a step of adding a binder and a solvent to the dielectric raw materials, mixing them to form slurries, and shaping the resulting slurries into inner-layer green sheets and outer-layer green sheets (shaping step), a step of forming a patterned conductive paste layer on the surface of the inner-layer green sheets using a conductive paste for inner electrodes (printing step), a step of stacking multiple inner-layer green sheets with the conductive paste layer formed thereon, placing the outer-layer green sheets on the top and bottom of the stack, and pressure-bonding the entire structure to produce a multilayer block (stacking step), a step of cutting the resulting multilayer block to produce multilayer chips (cutting step), a step of subjecting the resulting multilayer chips to debinding treatment and firing treatment to obtain body portions (firing step), and a step of forming outer electrodes (outer end surface electrodes and outer side surface electrodes) on the resulting body portions to produce multilayer ceramic capacitors (outer electrode formation step). The manufacturing conditions, furthermore, are controlled such that in the resulting multilayer ceramic capacitors, the intragranular void density in the inner-layer ceramic (Nᵢₙₙₑᵣ) and the intragranular void densities in the outer-layer ceramics (Nₒᵤₜₑᵣ) satisfy formula (1): Nₒᵤₜₑᵣ<Nᵢₙₙₑᵣ. The details of each step will be described below.

### Synthesis Step

In the synthesis step, primary element powders used to form ceramic dielectrics are synthesized. The primary element powders are powders of dielectrics having a perovskite structure (ABO₃), such as BaTiO₃ compounds. As the primary element powders, hydrothermally synthesized dielectric powders are used. This allows for producing multilayer ceramic capacitors including dielectric particles including a void therein (voided particles). As each primary element powder, a hydrothermally synthesized dielectric powder alone may be used, or, alternatively, a hydrothermally synthesized dielectric powder and a dielectric powder synthesized by a method other than the hydrothermal method may be used in combination. In addition, particle diameters may be adjusted by crushing the synthesized primary element powders.

The hydrothermally synthesized dielectric powders can be synthesized by subjecting a raw material including the A-site element of the perovskite structure (A-site raw material) and a raw material including the B-site element (B-site raw material) to hydrothermal reaction under high-temperature and high-pressure conditions. Specifically, placing the raw materials into a tightly sealed vessel, such as an autoclave, together with water and heating them causes hydrothermal reaction. The A-site raw material is a hydroxide, such as barium hydroxide (Ba(OH)₂). The B-site raw material is an oxide, such as titanium n oxide (TiO₂) or metatitanic acid (TiO(OH)₂), or its hydrate. The heating temperature can be about 150° C. or above and about 250° C. or below, although not limited. By drying the product obtained through the hydrothermal reaction, a dielectric powder can be obtained. To increase the crystallinity of the dielectric powder, furthermore, the product may be subjected to heat treatment. The heat treatment can be performed at a temperature of, for example, about 800° C. or above and about 1000° C. or below.

### Mixing Step

In the mixing step, secondary element (e.g., Ni, Re, Mg, Mn, Si, Al, and V) raw materials are mixed into the primary element powders to give dielectric raw materials. The secondary element raw materials can be known ceramic raw materials, such as oxides, carbonates, hydroxides, nitrates, organic acid salts, alkoxides, and/or chelate compounds. Besides the secondary element raw materials, furthermore, a composition-controlling agent for the primary element powder may be added. For example, adding a Ba raw material, such as barium carbonate (BaCO₃), when the primary element powders are barium titanate (BaTiO₃) powders would help control the composition of the primary element of the ceramic dielectrics. The mixing method is not particularly limited. An example is the method of weighing out the primary element powder and the secondary element raw materials and mixing and grinding them by a wet process, together with a grinding medium and water, using a ball mill. When the mixing is performed by a wet process, the mixture can be dried.

### Shaping Step

In the shaping step, a binder and a solvent are added to the dielectric raw materials, the materials are mixed to form slurries, and the resulting slurries are shaped into inner-layer green sheets and outer-layer green sheets. The binder can be a known organic binder, such as a polyvinyl butyral binder. The solvent, furthermore, can be a known organic solvent, such as toluene or ethanol. Additives, such as a plasticizer, may optionally be added. The shaping can be performed by a known method, such as RIP. The thickness of the shaped sheets is, for example, about 1 μm or less.

### Printing Step

In the printing step, a patterned conductive paste layer is formed on the surface of the inner-layer green sheets using a conductive paste. The conductive paste layer forms an inner electrode layer after firing. The conductive metal included in the conductive paste can be a conductive material such as nickel (Ni), copper (Cu), silver (Ag), or palladium (Pd), or an alloy including such metals. In addition, a ceramic element that acts as a common material may be added to the conductive paste. The method for forming the conductive paste layer is not particularly limited. Examples include methods such as screen printing and gravure printing.

### Stacking Step

In the stacking step, multiple inner-layer green sheets with the conductive paste layer formed thereon are stacked, and the outer-layer green sheets are placed on the top and bottom of the stack. Then the entire structure is pressure-bonded to produce a multilayer block. The inner-layer green sheets form the ceramic dielectric of the inner-layer portion of the multilayer ceramic capacitors (the inner-layer ceramic) through the firing step. The outer-layer green sheets form the ceramic dielectrics of the outer-layer portions (the outer-layer ceramics). The number of green sheets stacked can be adjusted such that a desired capacitance is achieved.

### Cutting Step

In the cutting step, the resulting multilayer block is cut to give multilayer chips. The cutting can be performed such that chips of a predetermined size are obtained, and that part of the conductive paste layers is exposed on the end surfaces of the multilayer chips. When multilayer ceramic capacitors according to an example embodiment of the present invention are manufactured, furthermore, the cutting can be performed such that a portion of the conductive paste layers is exposed on the side surfaces of the multilayer chips.

The resulting multilayer chips may optionally be subjected to barrel polishing treatment. This treatment allows for rounding the corner portions and/or edge portions of the green body portions.

### Firing Step

In the firing step, the multilayer chips are subjected to debinding treatment and firing treatment to give body portions. Through the firing treatment, the conductive paste layers and the inner-layer green sheets are co-sintered, forming the inner electrode layers and ceramic dielectric of the inner-layer portion. The outer-layer green sheets are sintered to form the ceramic dielectrics of the outer-layer portions.

The conditions for the debinding treatment can be determined according to the types of organic binders included in the green sheets and the conductive paste layers. The firing treatment, furthermore, can be performed at a temperature at which the multilayer chips are densified sufficiently. For example, it can be performed under conditions under which the chips are held at a temperature of about 1200° C. or above and about 1300° C. or below for 0 minutes or more and about 10 minutes or less. The firing, moreover, is performed in an atmosphere in which the primary element compound, such as BaTiO₃, is not reduced and in which the oxidation of the conductive material is limited. For example, it can be performed in a N₂—H₂—H₂O gas stream with a partial pressure of oxygen of about 1.8×10⁻⁹ to about 8.7×10⁻¹⁰ MPa. In addition, annealing treatment may be applied after the firing.

### Outer Electrode Formation Step

In the outer electrode formation step, outer electrodes (outer end surface electrodes and outer side surface electrodes) are formed on the body portions to produce multilayer ceramic capacitors. The formation of the outer electrodes can be performed by a known method. For example, a conductive paste including a conductive element, such as Cu or Ni, as its primary element is applied to the end surfaces and/or side surfaces of the body portions, on which extended inner electrode layers are exposed, and baked to form a base layer. The base layer may be formed by the method of applying a conductive paste to both end surfaces of the green body portions, which have yet to be fired, and then subjecting the green body portions to firing treatment. After the formation of the base layer, a plating coating, for example of Ni or Sn, can be formed on the surface of the base layer by applying electrolytic plating. Through this, multilayer ceramic capacitors are produced.

### Control of Intragranular Void Densities

In the manufacturing method according to this example embodiment, it is important to control the intragranular void densities in the inner-layer ceramic and the outer-layer ceramics (Nᵢₙₙₑᵣ and Nₒᵤₜₑᵣ). Specifically, the manufacturing conditions are controlled such that the intragranular void densities satisfy formula (1): Nₒᵤₜₑᵣ<Nᵢₙₙₑᵣ.

The method for controlling the intragranular void densities is not limited. An example is the method of adding grain growth accelerator materials or grain growth inhibitor materials to the primary element powders and adjusting their amounts. Examples of grain growth accelerator materials include zirconium (Zr), silicon (Si), vanadium (V), and/or aluminum (Al). The dielectric particles grow during the firing step. In this process, intragranular voids become smaller as grain growth proceeds and, in some cases, disappear. Adding grain growth accelerator materials to the outer-layer green sheets and setting their amounts higher than those in the inner-layer green sheets, therefore, would help limit the intragranular void densities in the outer-layer ceramics. In that case, the concentrations of the grain growth accelerator materials (such as Zr) in the outer-layer ceramics would be higher than those in the inner-layer ceramic in the finally obtained multilayer ceramic capacitors.

An alternative example is the method of adjusting the composition of the primary element powders. The primary element powders are perovskite oxides, which have a composition represented by the formula: ABO₃, typified by BaTiO₃. For perovskite oxides, grain growth is accelerated with decreasing molar ratio of the A-site element (e.g., Ba) to the B-site element (e.g., Ti) (A/B ratio). Reducing the molar ratio (A/B ratio) in the primary element powder for the outer-layer green sheets, therefore, would help limit the intragranular void densities in the outer-layer ceramics.

In addition, the method of adjusting the particle diameter of raw material particles, such as the primary element powders, is also possible. The smaller the raw material particles, the faster grain growth proceeds. By using powders with particle diameters smaller than that of the primary element powder for the inner-layer green sheets as the primary element powder for the outer-layer green sheets, therefore, the intragranular void densities in the outer-layer ceramics can be limited.

Another possible method is the method of adding a dielectric powder synthesized by a method other than the hydrothermal method, such as the solid-phase method, to the primary element powders. As stated earlier, whereas hydrothermally synthesized dielectric powders have intragranular voids, dielectric powders synthesized by methods other than the hydrothermal method have no intragranular voids. By using a hydrothermally synthesized dielectric powder and a dielectric powder synthesized by a method other than the hydrothermal method in combination, therefore, the intragranular void densities can be controlled. A specific example is the method of producing the inner-layer green sheets from a hydrothermally synthesized dielectric powder while producing the outer-layer green sheets from a mixture of a hydrothermally synthesized dielectric powder and a dielectric powder synthesized by the solid-phase method.

As long as the intragranular void densities in the inner-layer ceramic and the outer-layer ceramics can be controlled to satisfy the predetermined relationship, the method for controlling the intragranular void densities is not limited.

### EXAMPLES

This example embodiment will be more specifically described using the following examples and comparative examples. The present invention, however, is not limited to the following non-limiting examples.

### (1) Production of Multilayer Ceramic Capacitors

### Example 1

In Example 1, inner-layer green sheets and outer-layer green sheets were produced using a barium titanate (BaTiO₃) powder synthesized by the hydrothermal method as the primary element powder, and multilayer ceramic capacitors were produced using them. The specific production procedure is presented below.

### Synthesis of the Primary Element Powder

A barium titanate (BaTiO₃) powder was synthesized by the hydrothermal method. First, a titanium oxide (TiO₂) powder and a barium hydroxide (Ba(OH)₂) powder were weighed out, and purified water was added to them to produce a slurry. Then the produced slurry was placed into a tightly sealed vessel, and the temperature of the slurry was raised to 200° C. to 250° C. with stirring. Then the slurry was maintained at 200° C. to 250° C. for 4 to 24 hours to allow a liquid-phase reaction to proceed. After that, the internal pressure of the tightly sealed vessel was returned to atmospheric pressure, the heating of the tightly sealed vessel was terminated, and the slurry was allowed to stand. After cooling, the slurry was removed from the tightly sealed vessel and placed into a drying oven, followed by the evaporation of water. In such a manner, a hydrothermally synthesized BaTiO₃ powder with an average particle diameter of 130 nm was obtained.

### Production of Inner-Layer Green Sheets

Barium carbonate (BaCO₃) was added to the hydrothermally synthesized BaTiO₃ powder (average particle diameter, 130 nm), and the resulting mixture was wet-ground for 24 hours in water using a ZrO₂ ball mill (compounding) and then dried and subjected to heat treatment to yield a dielectric raw material. The amount of BaCO₃ added was adjusted such that the molar ratio (Ba/Ti ratio) in the ceramic dielectric of the inner-layer portion of the finally obtained multilayer ceramic capacitors was 1.0025. Subsequently, a polyvinyl butyral binder and ethanol as an organic solvent were added to the resulting dielectric raw material, and wet mixing was performed for a predetermined period of time using a ball mill to produce a slurry. By shaping this slurry into sheets, inner-layer green sheets were produced.

### Production of Outer-Layer Green Sheets

Barium carbonate (BaCO₃) and ZrO₂ were added to the hydrothermally synthesized BaTiO₃ powder (average particle diameter, 130 nm), and the resulting mixture was wet-ground for 24 hours in water using a ZrO₂ ball mill and then dried and subjected to heat treatment to yield a dielectric raw material. The amount of BaCO₃ added was adjusted such that the molar ratio (Ba/Ti ratio) in the outer-layer ceramics in the finally obtained multilayer ceramic capacitors was 1.0025. The amount of ZrO₂ added, furthermore, was set to 0.3% by mass in relation to the BaTiO₃ powder. Subsequently, a polyvinyl butyral binder and ethanol as an organic solvent were added to the resulting dielectric raw material, and wet mixing was performed for a predetermined period of time using a ball mill to produce a slurry. By shaping this slurry into sheets, outer-layer green sheets were produced.

### Production of Multilayer Bodies

To the surface of the resulting inner-layer green sheets, a Ni-based conductive paste was applied by screen printing to form patterns of conductive paste layers to serve as the inner electrode layers. After that, multiple inner-layer green sheets with the conductive paste layer formed thereon were stacked, and the outer-layer green sheets, without a conductive paste layer formed thereon, were placed on the top and bottom of the stack. By pressure-bonding the entire structure, a multilayer block was produced. Then the resulting multilayer block was cut using a dicing saw into multilayer chips. The stacking was performed such that the extended end portions of the conductive paste layers alternated. The cutting, furthermore, was performed such that the extended portions of the conductive paste layers were exposed on the end surfaces.

The resulting multilayer chips were subjected to heat treatment in a N₂ gas stream under the conditions of a maximum temperature of 270° C., and then subjected to heat treatment in a N₂—H₂O—H₂ gas stream under the conditions of a maximum temperature of 800° C. After that, the multilayer chips were fired in a N₂—H₂O—H₂ gas stream. The firing was performed under the conditions of a maximum temperature of 1230° C. to 1400° C., a temperature elevation rate of 20° C./minute to 60° C./minute, a retention time of 60 minutes, and a partial pressure of oxygen of 5.0×10⁻¹³ to 1.7×10⁻¹² MPa. Subsequently, heat treatment was applied in a N₂—H₂O—H₂ gas stream under the conditions of a maximum temperature of 1050° C.×60 minutes. Through this, body portions were obtained.

To the end surfaces of the body portions obtained through firing, to which the inner electrode layers had been extended, a conductive paste including copper (Cu) as its primary element was applied. After that, the applied conductive paste was baked at 900° C. to form the base layer of the outer electrodes (outer end surface electrodes). On the surface layer of the base layer, furthermore, Ni plating and Sn plating were performed in this order by wet plating. In such a manner, multilayer ceramic capacitors were produced.

The produced multilayer ceramic capacitors had a length L dimension of 1.0 mm, a dimension in the width direction W of 0.5 mm, and a dimension in the thickness direction T of 0.5 mm. In the inner-layer portion, furthermore, the thickness of the dielectric layers was 0.49 μm, the thickness of the inner electrode layers was 0.44 μm, and the number of dielectric layers was 470.

### Example 2

In Example 2, a hydrothermally synthesized BaTiO₃ powder (average particle diameter, 80 nm) was used instead of the hydrothermally synthesized powder BaTiO₃ (average particle diameter, 130 nm) during the production of the inner-layer green sheets. Except for this, multilayer ceramic capacitors were produced in the same manner as in Example 1. It should be noted that the hydrothermally synthesized BaTiO₃ powder (average particle diameter, 80 nm) was synthesized through the same procedure as the hydrothermally synthesized BaTiO₃ powder (average particle diameter, 130 nm), except that the slurry temperature during the hydrothermal was lowered.

### Example 3

In Example 3, during the production of the outer-layer ceramic green sheets, ZrO₂ was not added. The amount of BaCO₃ added, furthermore, was adjusted such that the molar ratio (Ba/Ti ratio) in the outer-layer ceramics was 1.0000. Except for these, multilayer ceramic capacitors were produced in the same manner as in Example 1.

### Example 4

In Example 4, the amount of ZrO₂ added during the production of the outer-layer ceramic green sheets was changed from 0.3% by mass to 0.5% by mass. Except for this, multilayer ceramic capacitors were produced in the same manner as in Example 1.

### Example 5

In Example 5, the duration of grinding during the production of the outer-layer ceramic green sheets was changed from 24 hours to 48 hours, with no ZrO₂ added. Except for this, multilayer ceramic capacitors were produced in the same manner as in Example 1.

### Example 6

In Example 6, multilayer ceramic capacitors were produced in the same manner as in Example 1.

### Example 7

In Example 7, during the production of the inner-layer ceramic green sheets, ZrO₂ was added together with BaCO₃, and its amount added (the amount of ZrO₂ added) was set to 0.1% by mass in relation to the BaTiO₃ powder. Except for this, multilayer ceramic capacitors were produced in the same manner as in Example 1.

### Example 8

In Example 8, a mixed powder including the hydrothermally synthesized BaTiO₃ powder (average particle diameter, 130 nm): 70% by mass and a BaTiO₃ powder obtained by solid-phase synthesis (average particle diameter, 130 nm): 30% by mass was used as the primary element powder during the production of the outer-layer ceramic green sheets. The amount of BaCO₃ added during the production of the outer-layer ceramic green sheets, furthermore, was adjusted such that the molar ratio (Ba/Ti ratio) in the outer-layer ceramics was 1.0050. Except for these, multilayer ceramic capacitors were produced in the same manner as in Example 1.

### Example 9

In Example 9, a mixed powder including the hydrothermally synthesized BaTiO₃ powder (average particle diameter, 130 nm): 85% by mass and a BaTiO₃ powder obtained by solid-phase synthesis (average particle diameter, 130 nm): 15% by mass was used as the primary element powder during the production of the outer-layer ceramic green sheets. During the production of the outer-layer ceramic green sheets, furthermore, ZrO₂ was not added. Moreover, the amount of BaCO₃ added was adjusted such that the molar ratio (Ba/Ti ratio) in the outer-layer ceramics was 1.0050. Except for these, multilayer ceramic capacitors were produced in the same manner as in Example 1.

### Example 10

In Example 10, during the production of the inner-layer ceramic green sheets, ZrO₂ was added together with BaCO₃, and its amount added (the amount of ZrO₂ added) was set to 0.1% by mass in relation to the BaTiO₃ powder. During the production of the outer-layer ceramic green sheets, furthermore, ZrO₂ was not added. Moreover, the amount of BaCO₃ added was adjusted such that the molar ratio (Ba/Ti ratio) in the outer-layer ceramics was 1.0000. Except for these, multilayer ceramic capacitors were produced in the same manner as in Example 1.

### Comparative Example 1

In Comparative Example 1, a mixed powder including the hydrothermally synthesized BaTiO₃ powder (average particle diameter, 130 nm): 10% by mass and a BaTiO₃ powder obtained by solid-phase synthesis (average particle diameter, 130 nm): 90% by mass was used as the primary element powder during the production of the inner-layer ceramic green sheets. The duration of grinding during the production of the outer-layer ceramic green sheets, furthermore, was changed from 24 hours to 12 hours, with no ZrO₂ added. Except for these, multilayer ceramic capacitors were produced in the same manner as in Example 1.

### Comparative Example 2

In Comparative Example 2, the duration of grinding during the production of the outer-layer ceramic green sheets was changed from 24 hours to 12 hours, with no ZrO₂ added. Except for this, multilayer ceramic capacitors were produced in the same manner as in Example 1.

### (2) Evaluations

For the multilayer ceramic capacitors produced in Examples 1 to 10 and Comparative Examples 1 and 2, the evaluation of characteristics was performed as follows.

### TEM Observation

Using a transmission electron microscope (TEM), a WT plane of the multilayer ceramic capacitor was observed to examine intragranular void densities. Specifically, a WT plane of the multilayer ceramic capacitor was exposed by polishing the capacitor to the middle in the length direction, and the capacitor was further processed to prepare an 80-nm thick TEM observation sample including the WT plane. Then a TEM observation of the resulting sample was performed. In this process, the cross-section was divided into the inner-layer portion and the outer-layer portions, and observation was performed for each of a portion of the ceramic dielectric near the middle in the W direction and the T direction in the inner-layer portion and the vicinity of the middle in the W direction and the T direction in an outer-layer portion. Then the number of voids present in dielectric particles was counted, and the number of voids per unit area (1 μm²) was calculated by dividing the obtained number by the area of the ceramic portion. For each of the inner-layer portion and the outer-layer portions, the same operation was performed at three points (n=3), and the average number of intragranular voids per unit area was determined as the intragranular void density.

It should be noted that near the side surfaces of the inner-layer portion, there are regions including no inner electrode layer (side margin portions). These side margin portions and the central portion of the inner-layer portion are obtained by firing the same green sheets (inner-layer green sheets). The ceramic dielectrics of the side margin portions, therefore, have a composition and/or a microscopic structure continuous with those of the ceramic dielectric of the inner-layer portion. Between the side margin portions and the inner-layer portion, therefore, no physical or chemical boundary exists. The percentages of intragranular voids in the side margin portions, furthermore, are comparable to the percentage of intragranular voids in the central portion of the inner-layer portion or, if grain growth has occurred, slightly smaller.

### SEM Observation

Using a scanning electron microscope (SEM), a WT plane of the multilayer ceramic capacitor was observed to examine the thickness of the dielectric layers and diameters (D50) of dielectric particles. Specifically, a cross-section (WT plane) of the multilayer ceramic capacitor was exposed by polishing the capacitor to the middle in the length (L) direction. Then, on the exposed cross-section, a midline in the width direction W was drawn, along with two lines on each side at regular intervals from this midline in the width direction W. The thickness of a dielectric layer in the inner-layer portion located near the middle in the thickness direction was measured on these five lines in total, and the average was reported as the thickness of the dielectric layers.

In addition, an SEM image of dielectric particles in dielectric layers in the exposed cross-section was captured under the conditions of a magnification of 5000×, an acceleration voltage of 15 kV, and a field of view of 30 μm×30 μm. In this process, the imaging was performed for the ceramic dielectric near the middle in the W direction and the T direction in the inner-layer portion. Then, using image processing software, the edges of all dielectric particles were recognized, and the cross-sectional areas of the particles were calculated. From these areas, equivalent circular diameters were calculated as the diameters of the particles. Excluding dielectric particles that were only partially imaged, the diameters of all dielectric particles included within the captured area were measured. Their average was determined, through which the average diameter of dielectric particles in the inner-layer ceramic (D50ᵢₙₙₑᵣ) was determined. In addition, imaging was performed for the vicinity of the middle in the W direction and the T direction in an outer-layer portion, and the average diameter of dielectric particles in the outer-layer ceramics (D50ₒᵤₜₑᵣ) was determined.

### Humidity Load Test

For 100 samples, a humidity load test was performed under the conditions of 85° C.-relative humidity of 85%-6.3 V. After 250 hours, 500 hours, or 1000 hours passed, the samples were removed from the test chamber, and the insulation resistance (IR) when a voltage of 6.3 V was applied for 60 seconds at room temperature was measured. With LogIR>4 being the criterion, the test was considered passed (o) if all 100 samples satisfied the criterion and failed (x) if there was one or more samples for which LogIR≤4. Based on the results of the moisture resistance test obtained, furthermore, an assessment was made according to the following criteria.
⊚: The samples passed the test at 1000 hours
o: The samples passed the test at 250 hours, but failed at 500 hours or 1000 hours
x: The samples failed the test at 250 hours

### (3) Evaluation Results

The evaluation results obtained for the multilayer ceramic capacitors in Examples 1 to 10 and Comparative Examples 1 and 2 are summarized in Table 1.

In Examples 1 to 10, the proportion of intragranular voids in the outer-layer portions (Nₒᵤₜₑᵣ) was smaller than the proportion of intragranular voids in the inner-layer portion (Nᵢₙₙₑᵣ). As a result, the results of the humidity load test were good, with the samples passing the test at 250 hours. In particular, in Examples 1, 2, and 4 to 7, the results of the humidity load test were excellent, with the samples passing the test even at 1000 hours.

Incidentally, in Examples 1 to 10, the results of the humidity load test vary. This is because the number of intragranular voids has a great impact on moisture resistance, but second to it, the solubility of the elements of grain boundaries in water also influences moisture resistance. When the elements of grain boundaries are highly soluble, moisture resistance decreases. For example, when the molar ratio (Ba/Ti) is increased, the amount of Ba in the ceramic becomes greater, and the Ba concentration at grain boundaries becomes higher. When the concentration of Ba at grain boundaries is high, the dissolution of the elements of the grain boundaries in water is more likely to occur. Moisture resistance, therefore, decreases. When the amount of Zr in a ceramic is large, furthermore, the Zr concentration at grain boundaries is high. Zr at grain boundaries limits the dissolution of the elements of the grain boundaries. Conversely, when the amount of Zr is small, the Zr concentration at grain boundaries is low, and the dissolution of the elements of the grain boundaries can no longer be limited. As a result, the moisture resistance period shortens.

Among Examples 1 to 10, therefore, in Example 8, in which the molar ratio was relatively high, moisture resistance was relatively low, with the result of the humidity load test being “o.” In addition, in Examples 3 and 10, in which the amount of Zr was relatively small, moisture resistance was also relatively low, with the result of the humidity load test being “o.” In Example 9, the result of the humidity load test was “o,” but the molar ratio was high, and the amount of Zr was small. As a result, the samples passed the test at 250 hours but failed at 500 hours.

For the multilayer ceramic capacitors in Comparative Examples 1 and 2, the proportion of intragranular voids in the outer-layer portions (Nₒᵤₜₑᵣ) was greater than the proportion of intragranular voids in the inner-layer portion (Nᵢₙₙₑᵣ). As a result, the results of the humidity load test were poor, with the samples failing the test at 250 hours.

TABLE 1
Characteristics of the Multilayer Ceramic Capacitors

| | Intragranular void | | | | | | | | | |
|---|---|---|---|---|---|---|---|---|---|---|
| | density(voids/μm²) | | | | | | | | | |
| | (average of fields | | | | | | | | | |
| | of view, n = 3, in a | | Zr concentration | | D50 of dielectric | | | | | |
| | 2-μm square area) | | (mass %) | | particles (nm) | | | | | |
| | Inner- | Outer- | Inner- | Outer- | Inner- | Outer- | | | | |
| | layer | layer | layer | layer | layer | layer | Results of the humidity load test | | | |
| | portion | portions | portion | portions | portion | portions | 250 h | 500 h | 1000 h | Overall |
| Example 1 | 12 | 6 | 0.10 | 0.40 | 180 | 235 | ◯ | ◯ | ◯ | ⊚ |
| Example 2 | 16 | 13 | 0.10 | 0.40 | 130 | 225 | ◯ | ◯ | ◯ | ⊚ |
| Example 3 | 11 | 6 | 0.10 | 0.10 | 175 | 230 | ◯ | ◯ | X | ◯ |
| Example 4 | 21 | 3 | 0.10 | 0.60 | 175 | 415 | ◯ | ◯ | ◯ | ⊚ |
| Example 5 | 13 | 12 | 0.10 | 0.15 | 185 | 205 | ◯ | ◯ | ◯ | ⊚ |
| Example 6 | 14 | 7 | 0.10 | 0.45 | 175 | 205 | ◯ | ◯ | ◯ | ⊚ |
| Example 7 | 8 | 7 | 0.20 | 0.42 | 210 | 255 | ◯ | ◯ | ◯ | ⊚ |
| Example 8 | 12 | 10 | 0.10 | 0.40 | 185 | 135 | ◯ | ◯ | X | ◯ |
| Example 9 | 12 | 9 | 0.10 | 0.10 | 180 | 125 | ◯ | X | X | ◯ |
| Example 10 | 12 | 8 | 0.20 | 0.10 | 185 | 225 | ◯ | ◯ | X | ◯ |
| Comparative | 2 | 13 | 0.10 | 0.05 | 182 | 181 | X | X | X | X |
| Example 1 | | | | | | | | | | |
| Comparative | 10 | 14 | 0.15 | 0.05 | 184 | 183 | X | X | X | X |
| Example 2 | | | | | | | | | | |

From these results, it is to be understood that according to this example embodiment, multilayer ceramic capacitors particularly superior in moisture resistance are provided.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
an inner-layer portion, in which at least one first inner electrode layer and at least one second inner electrode layer are alternately stacked with at least one dielectric layer including a ceramic dielectric interposed therebetween, the inner-layer portion including a first primary surface facing a stacking direction, a second primary surface opposite the first primary surface, a first side surface facing a width direction orthogonal to the first primary surface and the second primary surface, a second side surface opposite the first side surface, a first end surface facing a length direction, orthogonal to the first primary surface, the second primary surface, the first side surface, and the second side surface, and to which the first inner electrode layer is extended, and a second end surface opposite the first end surface and to which the second inner electrode layer is extended;
a first outer-layer portion including a ceramic dielectric and covering the first primary surface in the stacking direction;
a second outer-layer portion including a ceramic dielectric and covering the second primary surface in the stacking direction; and
a pair of outer end surface electrodes on the first end surface and the second end surface and coupled to each of the first inner electrode layer and the second inner electrode layer; wherein
each of the ceramic dielectrics of the inner-layer portion, the first outer-layer portion, and the second outer-layer portion includes a plurality of dielectric particles including a void therein; and
an intragranular void density in the ceramic dielectric in the inner-layer portion (Nᵢₙₙₑᵣ) and intragranular void densities in the ceramic dielectrics in the first outer-layer portion and the second outer-layer portion (Nₒᵤₜₑᵣ) satisfy formula (1): Nₒᵤₜₑᵣ<Nᵢₙₙₑᵣ.

2. The multilayer ceramic capacitor according to claim 1, wherein a Zr concentration in the ceramic dielectric in the inner-layer portion (Zrᵢₙₙₑᵣ) and Zr concentrations in the ceramic dielectrics in the first outer-layer portion and the second outer-layer portion (Zrₒᵤₜₑᵣ) satisfy formula (2): Zrᵢₙₙₑᵣ<Zrₒᵤₜₑᵣ.

3. The multilayer ceramic capacitor according to claim 1, wherein an average diameter of dielectric particles in the ceramic dielectric in the inner-layer portion (D50ᵢₙₙₑᵣ) and average diameters of dielectric particles in the ceramic dielectrics in the first outer-layer portion and the second outer-layer portion (D50ₒᵤₜₑᵣ) satisfy formula (3): D50ᵢₙₙₑᵣ<D50ₒᵤₜₑᵣ.

4. The multilayer ceramic capacitor according to claim 3, wherein the D50ᵢₙₙₑᵣ is about 130 nm or more and about 210 nm or less.

5. The multilayer ceramic capacitor according to claim 1, wherein the multilayer ceramic capacitor has a substantially rectangular parallelepiped shape and includes rounded corners or edge portions.

6. The multilayer ceramic capacitor according to claim 1, wherein the multilayer ceramic capacitor is a three terminal capacitor.

7. The multilayer ceramic capacitor according to claim 1, wherein the multilayer ceramic capacitor has a dimension in the length direction of about 0.2 mm or more and about 3.2 mm or less, a dimension in the width direction of about 0.1 mm or more and about 2.5 mm or less, and a dimension in the stacking direction of about 0.1 mm or more and about 2.5 mm or less.

8. The multilayer ceramic capacitor according to claim 1, wherein the voids are made from hydrothermally synthesized dielectric powder.

9. The multilayer ceramic capacitor according to claim 1, wherein a thickness of the at least one dielectric layer is about 0.5 μm or less, and the intragranular void density in the ceramic dielectric in the inner-layer portion is about 8 voids/μm² or more and about 18 voids/μm² or less.

10. The multilayer ceramic capacitor according to claim 1, wherein a thickness of the at least one dielectric layer is about 0.5 μm or less, and the intragranular void density in the in the ceramic dielectric in the inner-layer portion is about 11 voids/μm² or more and about 18 voids/μm² or less.

11. A multilayer ceramic capacitor comprising:
an inner-layer portion including at least one first inner electrode layer and at least one second inner electrode layer alternately stacked with at least one dielectric layer including a ceramic dielectric interposed therebetween, the inner-layer portion including a first primary surface facing a stacking direction, a second primary surface opposite the first primary surface, a first side surface facing a width direction orthogonal to the first primary surface and the second primary surface and to which the second inner electrode layer is extended, a second side surface opposite the first side surface and to which the second inner electrode layer is extended, a first end surface facing a length direction, orthogonal to the first primary surface, the second primary surface, the first side surface, and the second side surface, and to which the first inner electrode layer is extended, and a second end surface opposite the first end surface and to which the first inner electrode layer is extended;
a first outer-layer portion including a ceramic dielectric and covering the first primary surface in the stacking direction;
a second outer-layer portion including a ceramic dielectric and covering the second primary surface in the stacking direction;
a pair of outer end surface electrodes on the first end surface and the second end surface and coupled to the first inner electrode layer; and
a pair of outer side surface electrodes on the first side surface and the second side surface and coupled to the second inner electrode layer; wherein
each of the ceramic dielectrics of the inner-layer portion, the first outer-layer portion, and the second outer-layer portion includes a plurality of dielectric particles including a void therein; and
an intragranular void density in the ceramic dielectric in the inner-layer portion (Nᵢₙₙₑᵣ) and intragranular void densities in the ceramic dielectrics in the first outer-layer portion and the second outer-layer portion (Nₒᵤₜₑᵣ) satisfy formula (1): Nₒᵤₜₑᵣ<Nᵢₙₙₑᵣ.

12. The multilayer ceramic capacitor according to claim 11, wherein a Zr concentration in the ceramic dielectric in the inner-layer portion (Zrᵢₙₙₑᵣ) and Zr concentrations in the ceramic dielectrics in the first outer-layer portion and the second outer-layer portion (Zrₒᵤₜₑᵣ) satisfy formula (2): Zrᵢₙₙₑᵣ<Zrₒᵤₜₑᵣ.

13. The multilayer ceramic capacitor according to claim 11, wherein an average diameter of dielectric particles in the ceramic dielectric in the inner-layer portion (D50ᵢₙₙₑᵣ) and average diameters of dielectric particles in the ceramic dielectrics in the first outer-layer portion and the second outer-layer portion (D50ₒᵤₜₑᵣ) satisfy formula (3): D50ᵢₙₙₑᵣ<D50ₒᵤₜₑᵣ.

14. The multilayer ceramic capacitor according to claim 13, wherein the D50ᵢₙₙₑᵣ is about 130 nm or more and about 210 nm or less.

15. The multilayer ceramic capacitor according to claim 11, wherein the multilayer ceramic capacitor has a substantially rectangular parallelepiped shape and includes rounded corners or edge portions.

16. The multilayer ceramic capacitor according to claim 11, wherein the multilayer ceramic capacitor is a three terminal capacitor.

17. The multilayer ceramic capacitor according to claim 11, wherein the multilayer ceramic capacitor has a dimension in the length direction of about 0.2 mm or more and about 3.2 mm or less, a dimension in the width direction of about 0.1 mm or more and about 2.5 mm or less, and a dimension in the stacking direction of about 0.1 mm or more and about 2.5 mm or less.

18. The multilayer ceramic capacitor according to claim 11, wherein the voids are made from hydrothermally synthesized dielectric powder.

19. The multilayer ceramic capacitor according to claim 11, wherein a thickness of the at least one dielectric layer is about 0.5 μm or less, and the intragranular void density in the ceramic dielectric in the inner-layer portion is about 8 voids/μm² or more and about 18 voids/μm² or less.

20. The multilayer ceramic capacitor according to claim 11, wherein a thickness of the at least one dielectric layer is about 0.5 μm or less, and the intragranular void density in the in the ceramic dielectric in the inner-layer portion is about 11 voids/μm² or more and about 18 voids/μm² or less.
